(19) United States
(12) Patent Application Publication
(10) Pub. No.: US 2003/0183059 A1
(43) Pub. Date: Oct. 2, 2003

(54) Apparatus for a intermittent feeding of a strip shaped blank

(75) Inventor: Oskar Eigenmann, Arbon (CH)

Correspondence Address: Ladas & Parry, 26 West 61st Street, New York, NY, 10023, US

(73) Assignee: BRUDERER AG

(21) Appl. No.: 10/370,425

(22) Filed: Feb. 19, 2003

(30) Foreign Application Priority Data
Mar. 27, 2002 (EP) 02006964.7

(51) Int. Cl. B26F 1/14

(52) U.S. Cl. 83/684

(57) ABSTRACT

The feeding apparatus is driven intermittently by a electric servomotor with a drive shaft. The upper feeding roller is held clamped in a bipartite upper shaft assembly between a shaft portion located adjacent the electric servomotor and a shaft portion located remote from the electric servomotor. The lower feeding roller is held clamped in a bipartite lower shaft assembly between a shaft portion located adjacent the electric servomotor and a shaft portion remote from the electric servomotor. The upper shaft assembly is supported in a rocker. The transmission of the driving force from the electric servomotor to the upper shaft assembly proceeds via a Oldham-type coupling. The transmission of the driving force from the upper shaft assembly to the lower shaft assembly proceeds via spur gear wheels. The connection between the drive shaft of the electric servomotor and the upper shaft assembly is accomplished by a multi-part clamping sleeve device. The one spur gear wheel and a part of the Oldham-type coupling are made integral with a part of the multi-part clamping sleeve device.

### CROSS REFERENCE TO RELATED APPLICATIONS

This present application is based on the European Patent Application No. 02,006,964.7, filed Mar. 27, 2002, of which the priority is claimed and the disclosure of which shall be considered included in this application by reference.

### BACKGROUND OF THE INVENTION

1. Field of the Invention

The present invention relates to an apparatus for a intermittent feeding of a strip shaped blank to a punch press which is equipped with tools adapted for a intermittent working of the strip shaped blank, which apparatus includes at least one intermittently operating electric servomotor with a drive shaft, a upper shaft assembly and a upper roller mounted to the upper shaft assembly, a lower shaft assembly and a lower roller mounted to the lower shaft assembly, of which rollers at least one is drivingly connected to the at least one electric servomotor, which rollers are adapted to engage the strip shaped blank to be fed by a clamping of same at both its sides and to feed same intermittently by a intermittent rotational movement.

2. Description of the Prior Art

The punch presses which are referred to herein are specifically high speed punch presses with a number of strokes up to 2000 strokes per minute. These punch presses are equipped with tools for working one (or several) strip shaped blank(s) fed to same, whereby punching operations, embossing operations, bending operations, a riveting, a producing of threads, etc. are performed.

The moving of the strip shaped blank which is worked in the punch press proceeds, thereby, intermittently, that is stepwise. Quite obviously there is no forward movement or advancing of the strip shaped blank during a given operating step, e.g. a punching operation. The blank is quite often positioned, that is arrested by positioning pins mounted in the tools. After a given operating step, for instance after a punching tool has been retracted out of the punched hole, the strip shaped blank is advanced by a pre-set distance and then again stopped, so that a next following operating step can be performed.

The feeding or advancing, resp. movement of the strip shaped blank is performed by a (or several, located at the entry and the exit side of the punch press) feeding or advancing, resp. apparatus (or apparatuses, resp.) which pulls the strip shaped blank intermittently off a delivery spool and feeds same to the punch press.

A great many of such feeding apparatuses have become known in various designs. According to one of these known designs the feeding apparatus comprises clamping tongues. These clamping tongues perform a linear reciprocating movement. In order to advance the strip shaped blank it is clamped by these tongues. During the returning movement the strip shaped blank is released by the tongues. At certain operating procedures the blank is, furthermore, released temporarily for a short time during the for instance punching procedure itself. A further known embodiment of such feeding apparatuses comprises oscillating segment rollers which perform rotational movements. For an advancing the strip-shaped blank is clamped by the segment rollers which rotate in the direction of the feeding of the blank. During the reverse rotating into the starting position the strip shaped blank is released by the segment rollers. Also in this case the blank is released temporarily for a short time during the punching procedure. Due to the high number of strokes of modern high speed presses extremely high accelerations and decelerations occur due to the large forces of inertia of the structural parts of the feeding apparatuses. Further forces of inertia are produced by the blank itself to be worked and drawn off the delivery spool.

As a supplement to the known mechanically driven feeding apparatuses, feeding apparatuses have become known which are driven by a electric servomotor. Such servomotors are produced and sold by several companies. The operation of these servomotors is controlled electronically. These new feeding apparatuses have feeding members which are of a completely cylindrical design in form of feeding rollers mounted on shafts and which rotate intermittently in always the same sense of rotation.

When performing a working operation in a press it is often necessary to achieve an extremely precise aligning of the strip-shaped blank, for instance when the punch press, to which the feeding apparatus is allocated is equipped with a so-called multiple-tool or follow-on tool. According to one procedure positioning pins are used which are moved into pre-punched holes immediately ahead of the working step proper, so to allow a precise punching. During the actual working step, e.g. during the through punching for producing a hole in the blank, the strip-like blank is held and centered exclusively by these positioning pins and the clamping action by the rollers of the feeding apparatus is also released. This means, that at least one of the rollers must be lifted off the strip shaped blank. Therefore, this roller must, together with the shaft carrying same, not only perform a intermittent rotational movement, but also a oscillating lifting movement perpendicularly to the strip-shaped blank.

Whereas, now, a number of the until now present mechanical structural elements with their masses of inertia are done away with by the use of the known electric servomotors in feeding apparatuses, known feeding apparatuses driven by electrical servomotors include still a considerable number of mechanical structural elements with their masses of inertia.

Because these structural members perform due to their masses during the high acceleration and deceleration also twisting movements which negatively influence the precision of the working and, furthermore, are prone to oscillate, it is still necessary to pay a large attention to these structural members also in case of a drive by a electric servomotor.

A design of a feeding apparatus with a electric servomotor has become known, in which the drive shaft of the electric servomotor in made integral with the shaft of the roller and the roller, and in which the drive connection between mentioned drive and roller shafts, resp. takes place at the ends of the shafts located remote from the electric servomotor.

This design features, however, various drawbacks which negatively influence the precision of the working process.

Because one of the shafts of the rollers is integral with the motor shaft, the motor shaft and, therefore, the entire drive motor must be of a custom made design, a special design. It is not possible to use a generally available series motor, an off the shelf motor.

Depending from a respective product to be produced various strip-shaped blanks are fed to a punch press and such strip-shaped blanks are, furthermore, worked and processed differently. Because the feeding rollers must be correspondingly designed to suit the strip-shaped blank for feeding same, the feeding rollers must be exchanged from case to case. Moreover, feeding rollers are subjected to wear and must be re-ground. This means, that also in such a case worn feeding rollers must be replaced by fresh feeding rollers, because obviously the operation of the punch press should not be interrupted for a prolonged time during the extremely precise regrinding process.

In order to demount the shafts for a exchanging of the rollers at the above described design, the motor shaft which is made integral with the shaft of the roller must be demounted completely. Additionally, it is necessary to open the chambers for the lubricating oil, the lubricant of the respective bearings.

The transmitting of the driving by gear wheels from the one roller shaft made integrally with the motor shaft to the other roller shaft, thus from the upper shaft to the lower shaft, occurs at the shaft ends which are remote from the servomotor. This leads to a long distance of twist from the center of the one (directly driven) roller to the other roller, a situation which has a extremely negative result regarding the behaviour of the synchronism of the two rollers and conclusively regarding the precision of the feed. Since a movement of the upper shaft in a radial direction towards the lower shaft and away from same occurs, a coupling, e.g. a Oldham-type coupling which allows such a movement must be present between these two shafts. At the mentioned known design this coupling is also arranged at the ends of the shafts which are remote from the servomotor, wherewith a further intricate support bearing of the Oldham-shaft is present and a additional rotating mass is present which causes twisting.

### SUMMARY OF THE INVENTION

Hence, it is a general object of the invention to provide an apparatus for a intermittent feeding of a strip shaped blank to a punch press which is equipped with tools adapted for a intermittent working of the strip shaped blank, of which the structural members have minimal masses of inertia, have symmetrical twisting distances and allow a extremely simple demounting of the rollers for a exchange of its rollers.

A further object of the invention is to provide an apparatus of the kind mentioned above, in which each shaft assembly comprises a first shaft portion located axially adjacent the servomotor, and a second shaft portion located axially at a distance from the first shaft portion, and in which a respective roller is held in a clamped state between a respective first shaft portion and a respective second shaft portion.

Still a further object of the invention is to provide an apparatus for a intermittent feeding of a strip shaped blank, which apparatus comprises an electric servomotor, at least one shaft assembly and a roller mounted to the shaft assembly, which shaft assembly has a first shaft portion located axially adjacent the electric servomotor and a second shaft portion located axially at a distance from the first shaft portion and remote from the servomotor, comprises further a roller located axially between the first and the second shaft assembly, and comprises threaded tightening bolts, each extending in axial direction through a respective second shaft portion located remote from the servomotor and resting against said second shaft portion, and in which each threaded tightening bolt is threadingly engaged in a respective first shaft portion located adjacent said servomotor, by means of which threaded tightening bolts the respective first and second shaft portions are tightened against each other and accordingly against a respective roller located therebetween, so that each roller is held between respective shaft portions in a clamped state.

Yet a further object of the invention is to provide an apparatus for a intermittent feeding of a strip shaped blank, which apparatus includes a electric servomotor with a drive shaft, a upper roller and a lower roller adapted to feed a strip-shaped blank clamped therebetween, in which the drive shaft of the servomotor is connected to the upper roller through a coupling device adapted to allow radial relative movements.

A further object of the invention is to provide an apparatus for a intermittent feeding of a strip shaped blank, which apparatus includes a frame, a electric servomotor with a drive shaft, a upper shaft structure supporting a upper roller and a lower shaft structure supporting a lower roller, which rollers are adapted to feed a strip-shaped blank clamped therebetween, in which the drive shaft of the electric servomotor is connected through a multi-part coupling device adapted to allow radial relative movements of the upper shaft structure, and in which the lower shaft structure is supported to rotate freely in the frame of the apparatus.

Still further object of the invention is to provide an apparatus for a intermittent feeding of a strip shaped blank which apparatus includes a electric servomotor with a drive shaft, a upper shaft assembly wit ha roller and a lower shaft assembly with a roller, in which each shaft assembly comprises a first shaft portion located axially adjacent the servomotor, and a second shaft portion located axially at a distance from the respective first shaft portion and remote from the electric servomotor, and in which a respective roller is held in a clamped state between a respective first shaft portion and a respective second shaft portion, and in which the first shaft portion of the lower shaft structure located axially adjacent the electric servomotor is connected to the drive shaft of the electric servomotor.

The advantages gained by the invention are seen substantially in that the moving structural members have a small mass of inertia, that small distances of twisting are present and the maintenance of structural members which are subject to wear can proceed quite easily in that the design of the structural members which are subject to a maintenance can be quite simple.

Due to the connection between the shaft portions by threaded tightening bolts it is made possible that a demounting of the rollers can be accomplished by a applying of tools from the outside, so that the oil chambers in which the lube oil is contained must not be opened.

Also, it is possible to use a standard off-the-shelf series motor, which allows a large flexibility regarding the driven structures, specifically regarding a further development of such structures. Moreover, there is no need for a special support or bearing, resp. of the shaft of the Oldham-type coupling because such is taken over by the motor bearing. Because no additional shaft coupling is needed, the total rotating mass is smaller.

Since the ends of the shafts at the side remote from the electric servomotor are completely freely accessible, it is when demounting the rollers merely necessary to displace the shaft section located remote from the electric servomotor somewhat after the clamping screw bolts have been removed by a small axial distance.

### BRIEF DESCRIPTION OF THE DRAWINGS

The invention will be better understood and objects other than those set forth above will become apparent when consideration is given to the following detailed description thereof. Such description makes reference to the annexed drawings, wherein

FIG. 1 is a section through a first embodiment of the apparatus of the present invention;

FIG. 2 illustrates a portion of FIG. 1, drawn on a enlarged scale;

FIG. 3 illustrates the first and second section of the upper shaft structure and the lower shaft structure, including the upper and the lower feeding roller, shown in an axially exploded view;

FIG. 4 is a section along line IV-IV of FIG. 1;

FIG. 5 is a section along line V-V of FIG. 1;

FIG. 6 is a section along line VI-VI of FIG. 1;

FIG. 7 illustrate the detail A in FIG. 6, shown on a enlarged scale;

FIG. 8 is a section through a part of the apparatus, in a state in which the electric servomotor with the driving gear wheel and the cross-type disc of the Oldham-type coupling are dismounted;

FIG. 8a illustrates the flange of the electric servomotor with the driving gear wheel in the mounted state, and a part of the Oldham-type coupling;

FIG. 8b illustrates the cross-type disc of the Oldham-type coupling;

FIG. 9 is a section through a further embodiment of the apparatus of the present invention; and

FIG. 10 the demounted drive for the lower shaft structure according to the embodiment illustrated in FIG. 9 and FIG. 10.

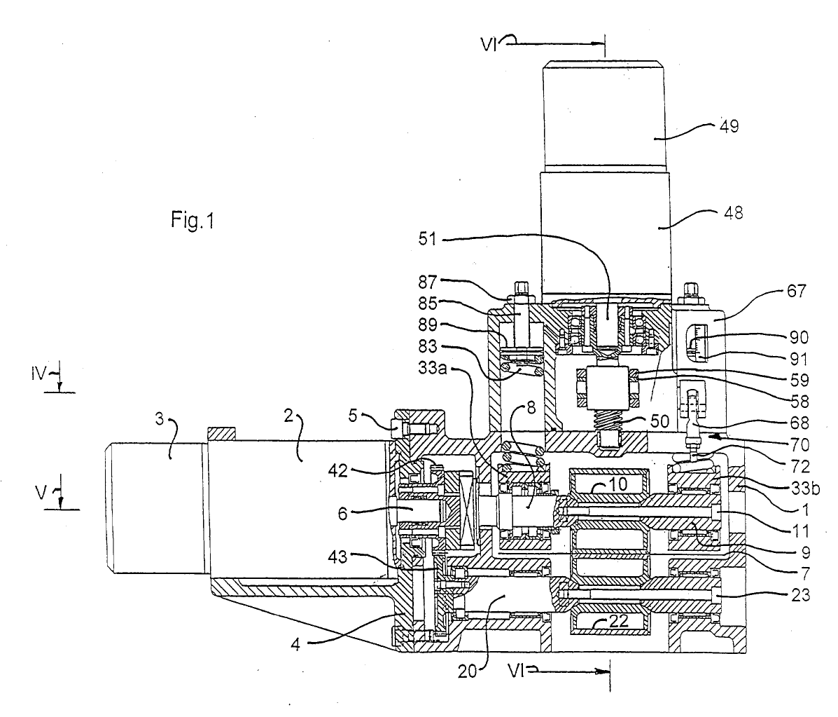

### DETAILED DESCRIPTION OF THE INVENTION

The apparatus has a frame 1. A first electric servomotor 2, of which the electronic control 3 is shown in a simplified manner is mounted at its flange 4 through threaded bolts 5 to the frame 1.

This first electric servomotor 2 is controlled in a manner which as such is generally known so that it performs step-wise intermittent rotational movements. The duration and the extends of a respective step of the rotational movement are controlled in dependance from the working process to be done in the adjacent following punch press. This electric servomotor 2 includes a drive shaft 6.

A upper shaft assembly 8, 9 with a upper feeding roller 10 and a lower shaft assembly 20, 21 with a lower feeding roller 22 are located in the frame 1, which feeding rollers 10, 22 are to feed the strip-shaped blank 7, generally a metal strip, in a intermittent fashion.

The upper shaft assembly 8, 9 is composed of a first shaft portion 8 located axially adjacent the electric servomotor 2, and of a second shaft portion 9 located axially at a distance from the first shaft portion 8 and remote from the electric servomotor 2. The upper feeding roller 10 is held between these two shaft portions 8, 9 in a clamped state.

A threaded tightening bolt 11 extends axially through the second shaft portion 9 located remote from the electric servomotor 2, which threaded tightening bolt 11 rests against the second shaft portion 9 and is threadingly engaged in the first shaft portion 8 located adjacent the electric servomotor 2.

The two shaft portions 8, 9 are held tightened against each other by this threaded tightening bolt 11, so that the upper feeding roller 10 which is located between these shaft portions 8, 9 is firmly held between the two shaft portions 8, 9 in a clamped state.

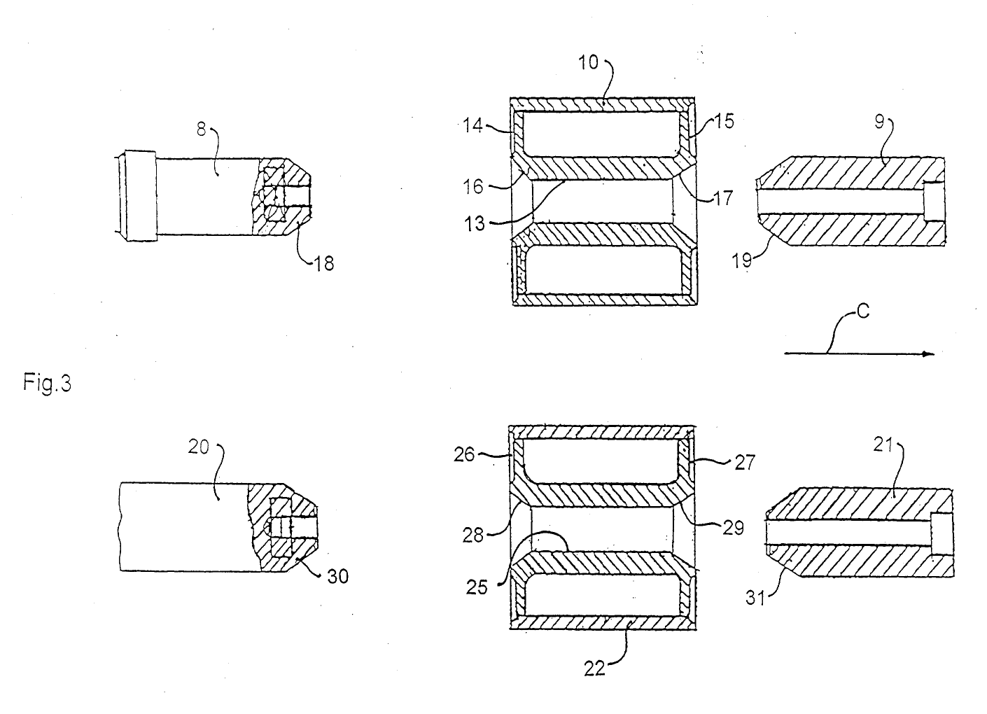

This upper feeding roller 10 which consists of several parts and is of a quite light structure features the shape of a hollow circular cylinder having a axially extending inner chamber 12 with a inner circumferential wall 13 and two end surface portions 14 and 15. See hereto FIG. 3.

The transition portion 16 between the end surface portion 14 and the inner circumferential wall 13 of the inner chamber 12 features the geometrical shape of the jacket of a truncated cone. The transition portion 17 extending between the end surface portion 15 and the inner circumferential wall 13 of the inner chamber 12 features in the same manner the geometrical shape of the jacket of a truncated cone.

The ends of the shaft portions 8, 9 which face each other include also a portion 18 and 19, resp. in the geometrical shape of the jacket of a truncated cone.

It can be seen clearly, therefore, that after the threaded tightening bolt 11 has been tightened, the respective portions 16, 18 and 17, 19 which have the geometric shape of a truncated cone abut each other so that the upper feeding roller 10 located between these shaft portions is firmly held in a clamped and guided state.

As also can be seen clearly, when the upper feeding roller 10 is to be dismounted it is merely necessary to loosen and unscrew the threaded tightening bolt 11 and to pull is a little out through a opening in the frame 1, through which opening the threaded tightening bolt 11 is accessible. Thereafter, the feeding roller can be demounted and removed without any further ado.

This state is illustrated on a purely exemplary basis in connection with the still to be described lower shaft portions 20, 21 and the lower feeding roller 22 in FIG. 3. The illustrated axial distances, which will be entered into further below are designed in a exaggerated manner.

The lower shaft assembly 20, 21 is also composed of a first shaft portion 20 located axially adjacent the electric servomotor 2 and of a second shaft portion 21 located axially at a distance from the first shaft portion 20 and remote from the electric servomotor 2. The lower feeding roller 22 is held between these two shaft portions 20, 21 in a clamped state.

A threaded tightening bolt 23 extends axially through the second shaft portion 21 located remote from the electric servomotor 2, which threaded tightening bolt 23 rests against the second shaft portion 21 and is threadingly engaged in the first shaft portion 20 located adjacent the electric servomotor 2.

The two shaft portions 20, 21 are held tightened against each other by this threaded tightening bolt 23, so that the lower feeding roller 22 which is located between these shaft portions 20, 21 is firmly held in a clamped state.

This lower feeding roller 22 which consists of several parts and is of a quite light structure features the shape of a hollow circular cylinder having a axially extending inner chamber 24 with a inner circumferential wall 25 and two end surface portions 26 and 27. The transition portion 28 extending between the end surface portion 26 and the inner circumferential wall 25 of the inner chamber 24 features the geometrical shape of the jacket of a truncated cone. The transition portion 29 extending between the end surface portion 27 and the inner circumferential wall 25 of the inner chamber 24 features in the same manner the geometrical shape of the jacket of a truncated cone.

The ends of the shaft portions 20, 21 which face each other include also a portion 30 and 31, resp. in the geometrical shape of the jacket of a truncated cone.

It can be seen clearly, therefore, that after the threaded tightening bolt 23 has been tightened, the respective portions 28, 30 and 29, 31 which have the geometrical shape of a truncated cone abut each other so that the lower feeding roller 22 located between these shaft portions is firmly held in a clamped and guided state.

As also can be seen clearly is that if the lower feeding roller 22 is to be dismounted it is merely necessary to loosen and unscrew the threaded tightening bolt 23 and to pull it out through a opening in the frame 1, through which opening the threaded tightening bolt 23 is accessible. Thereafter, the feeding roller 22 can be dismounted and removed without any further ado.

This state is illustrated in FIG. 3.

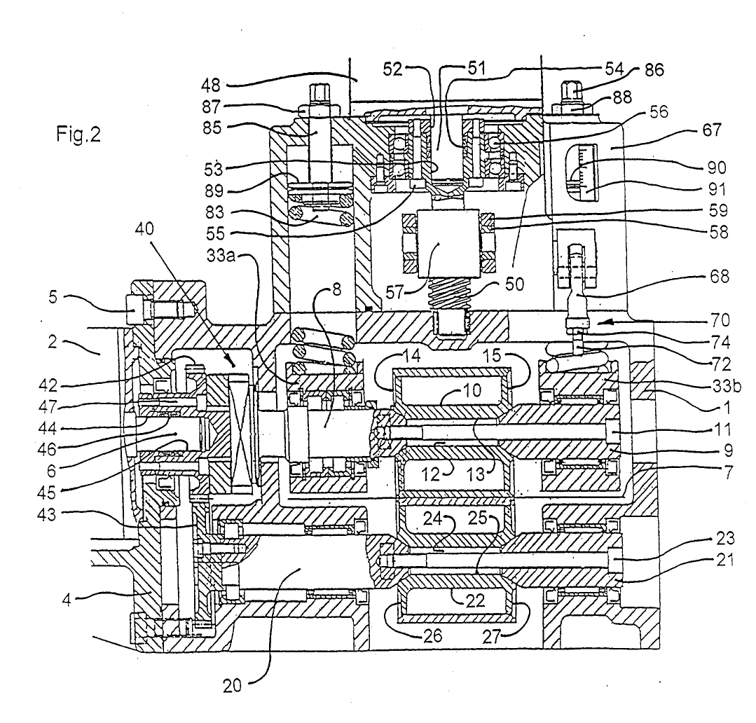

The first shaft portion 8 of the upper shaft assembly which shaft portion 8 is located adjacent the electric servomotor 2 and the first shaft portion 20 of the lower shaft assembly which shaft portion 20 is located adjacent the electric servomotor 2 remain stationary, such as e.g. illustrated in FIG. 2. Thus, they are not displaced. The second shaft portion 9 of the upper shaft assembly which shaft portion 9 is located remote from the electric servomotor 2 and the second shaft portion 21 of the lower shaft assembly which shaft portion is located remote from the electric servomotor 2 have been, after the threaded tightening bolts have been loosened, displaced axially in the direction of the arrow G. Accordingly, the feeding rollers 10, 22 lie exposed and can be removed from the shafts. It is to be noted that the axial distances between the structural members illustrated in FIG. 3 are shown exaggerated. The free space between the respective shaft portions, i.e. the distance between these shaft portions must be only that large that the feeding rollers, in order to remove them, can be displaced freely in the radial direction.

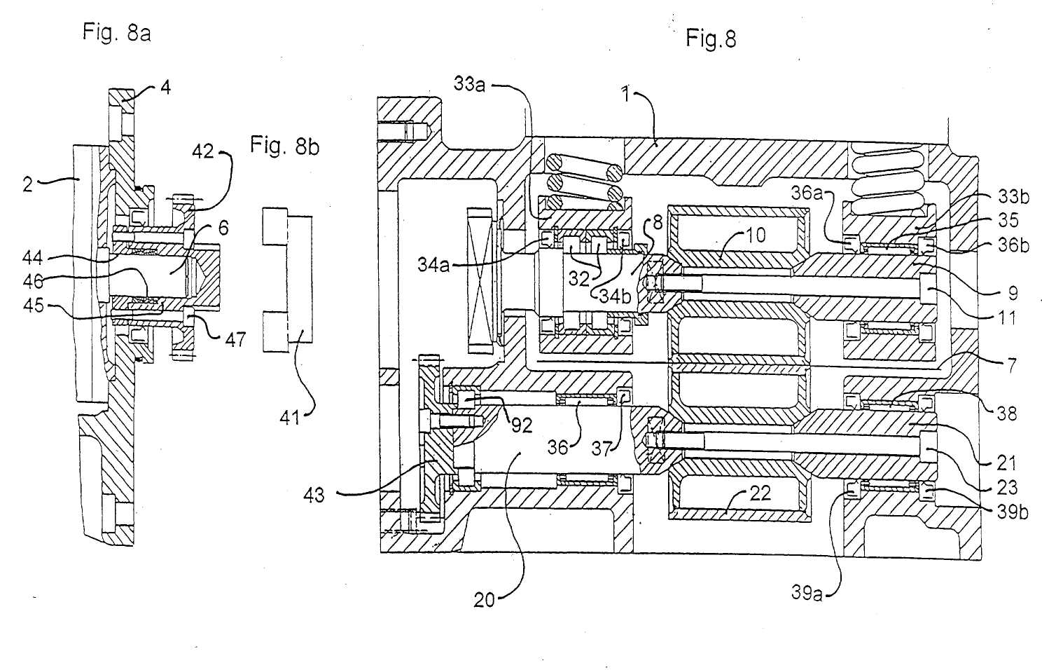

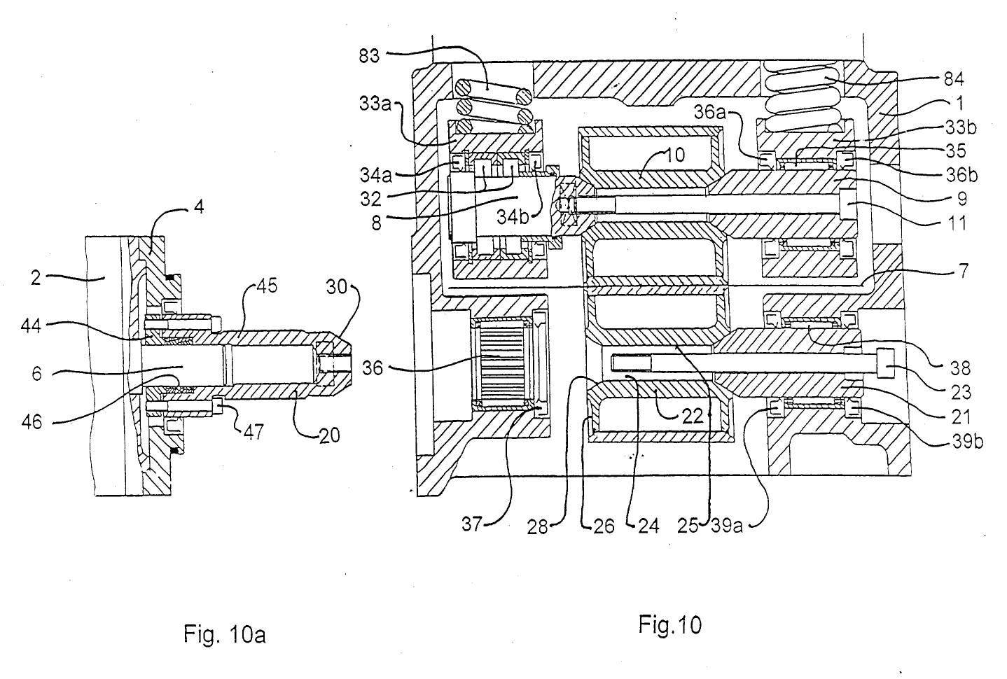

Reference is now made to FIGS. 8 and 10. The first shaft portion 8 of the upper shaft assembly which shaft portion 8 is located axially adjacent the electric servomotor 2 is supported through a roller bearing 32 in a rocker 32 still to be described, i.e. in the rocker portion 33b. The chamber of the lubricant of the roller bearing 35 is sealed off by seals 34a, 34b.

The second shaft portion 9 of the upper shaft assembly which shaft portion 9 is located remote from the electric servomotor 2 is supported through a roller bearing 35 in the rocker portion 33b. The chamber of the lubricant of the roller bearing 35 is sealed off by seals 36a, 36b.

The first shaft portion 20 of the lower shaft assembly which shaft portion 20 is located adjacent the electric servomotor 2 is supported by roller bearings 36 and 92 in frame 1. The chamber of the lubricant of the roller bearing 36 is sealed off by a seal 37.

The second shaft portion 21 of the lower shaft assembly which shaft portion 21 is located remote from the electric servomotor 2 is supported in the frame 1 by a roller bearing 38. The chamber of the lubricant of the roller bearing 38 is sealed of by seals 39a, 39b.

Accordingly, it can be seen that each bearing of the shaft portions 8, 9, 20, 21 is located in its own lubricant chamber and accordingly that the demounting of the feeding rollers 10, 22 can be accomplished without any opening of lubricant chambers. Accordingly, the respective exchanging of the feeding rollers 10, 22 can be done in a quite simple manner.

According to a first preferred embodiment the upper shaft assembly supported in the rocker 33, i.e. more precisely the first shaft portion 8 of the upper shaft structure located axially adjacent the electric servomotor 2 is drivingly connected to the first electric servomotor.

The first shaft portion 8 is connected to a Oldham-type coupling 40 of which the cross-type disc 41 is illustrated separately in FIG. 8. This Oldham-type coupling 40 is necessary because the first shaft portion 8 (and obviously all parts of the apparatus which are connected to the first shaft portion) performs lateral movements relative to the as such stationary (except of course the rotating) drive shaft 6 of the electric servomotor 2.

This Oldham-type coupling 40 is followed by a upper spur gear 42 which meshes with a lower spur gear 43, which in turn is connected to the first shaft portion 20 of the lower shaft assembly located adjacent the servomotor 2.

The coupling of the upper spur gear 42 to the drive shaft 6 of the electric servomotor 2 is accomplished by a multi-part clamping sleeve device with a first clamping sleeve part 44 and a second clamping sleeve part 45.

The co-acting of the clamping sleeve parts 44 and 45 is performed by annular clamping elements 46. The clamping sleeve screw bolts are identified by the reference numeral 47.

The upper spur gear 42 is made integral with the second clamping sleeve part 45, so that a considerable saving on moving masses is achieved.

According to a preferred embodiment a portion of the Oldham-type coupling is also made integral with the second clamping sleeve part 45.

According to a further preferred embodiment no spur gears are present, so that the lower feeding roller 22 is rotated exclusively by a frictional engagement with the metal strip 7.

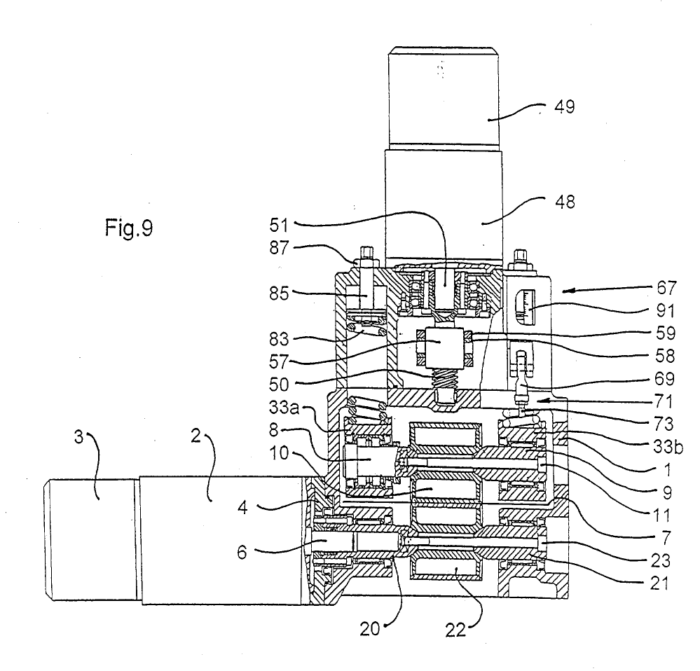

A still further embodiment is illustrated in FIGS. 9, 10, 10a. According to this embodiment the upper feeding roller 10 is rotated by a frictional engagement with the metal strip.

In this embodiment the first shaft portion 20 of the lower shaft assembly is driven by the electric servomotor 2. This shaft portion 20 is, thereby, made integral with the second clamping sleeve part 45, so that again a minimal rotating mass is present.

In the following, the lifting movement of the upper shaft assembly, that is the parts of the apparatus allocated to the upper feeding roller 10 will now be described.

A further electric servomotor 48 is located on top of a threaded spindle housing 67 of the feeding apparatus. Its electronic control, i.e. the housing thereof, is identified by the reference numeral 49.

This further electric servomotor 48 runs oscillatingly, thus it charges its sense of rotation after each rotating movement step.

This electric servomotor 48 serves for a driving of a threaded spindle 50. The drive shaft of the electric servomotor 48 is identified by the reference numeral 51. The connection between the drive shaft 51 of the electric servomotor 48 and the threaded spindle 50 is accomplished by a multi-part clamping sleeve device which includes a first clamping sleeve part 53 and annular clamping elements 54. The clamping sleeve parts 52, 53 are tightened against each other by clamping screw bolts 55.

The second clamping sleeve part 53 is supported in the threaded spindle housing 67 by roller bearings 56. The threaded spindle 50 is, furthermore, made integral with the second claming sleeve part 53. Thus, for assembling the threaded spindle 50 is initially mounted into the threaded spindle housing 67 together with the second clamping sleeve part 53 by agency of the roller bearings 56. Thereafter, the first clamping sleeve part 52 is set onto the second clamping sleeve part 53 and the drive shaft 51 of the electric servomotor 48 is set thereinto. Therefore, the servomotor 48 is aligned by the threaded spindle 50.

In other words, the threaded spindle 50 is supported free from play independent from the electric servomotor 48, because its position is determined by the already present position of the threaded spindle.

Because annular clamping elements are used for connection to the smooth shaft of the servomotor, a standard servomotor, thus no custom made design an be used.

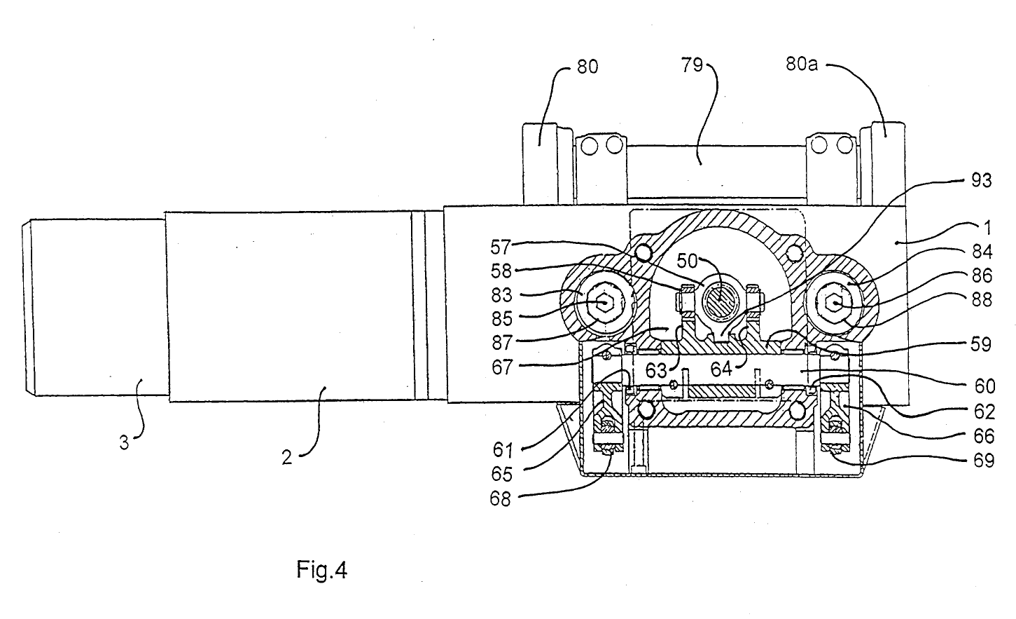

A adjusting nut 57 is arranged on the threaded spindle 50. This adjusting nut 57 is 58 in engagement with a rocker arm in form of a double arm lever 59 via sliders 58. As can be seen in FIG. 4, the adjusting nut 57 has a projection 93 which engages the rocker arm 59 wherewith the adjusting nut 57 is secured against a rotating.

This double arm lever 59 is of a two part design. The first part consists of the fork-like arranged first arms 63, 64 in which the slider 58 is located. These arms 63, 64 extend to a shaft 60, the lifting shaft, which is supported in the threaded spindle housing 67. The shaft 60 is sealed oiltight by seals 61, 62, so that a closed threaded spindle housing 67 as a closed lubrication oil chamber is present, in which the threaded spindle 50 and the above described structural members are located in a maintenance-free manner.

The shaft 60 projects at both its ends out of the threaded spindle housing 67. Forked lever arms 65, 66 are clamped onto these ends. The forked lever arms 65, 66 form the second part of the double arm lever 59.

The forked lever arms 65, 66 are pivotally mounted through ball end connections to respective upper shaft portions 68 and 69, resp. of control rods 70, 71, resp., which upper shaft portion 68 and 69, resp. are threadingly engaged with are respective lower shaft portions 72 and 73, resp.

Because the upper shaft portions 68 and 69, resp. of the control rods 70 and 71, resp. are threadingly engaged with the lower shaft portions 72 and 73, resp., the length of the control rods 70 and 71 and accordingly the position of the rocker 33 can be adjusted and set in a precise manner. The shaft portions 68 and 69, resp., and 72 and 73, resp. are locked against rotation by lock nuts 74 and 75, resp.

The control rods 70 and 71, resp., that is their lower shaft portions 72 and 73, resp. engage the rocker 33, that is the two rocker portions 33a and 33b, resp.

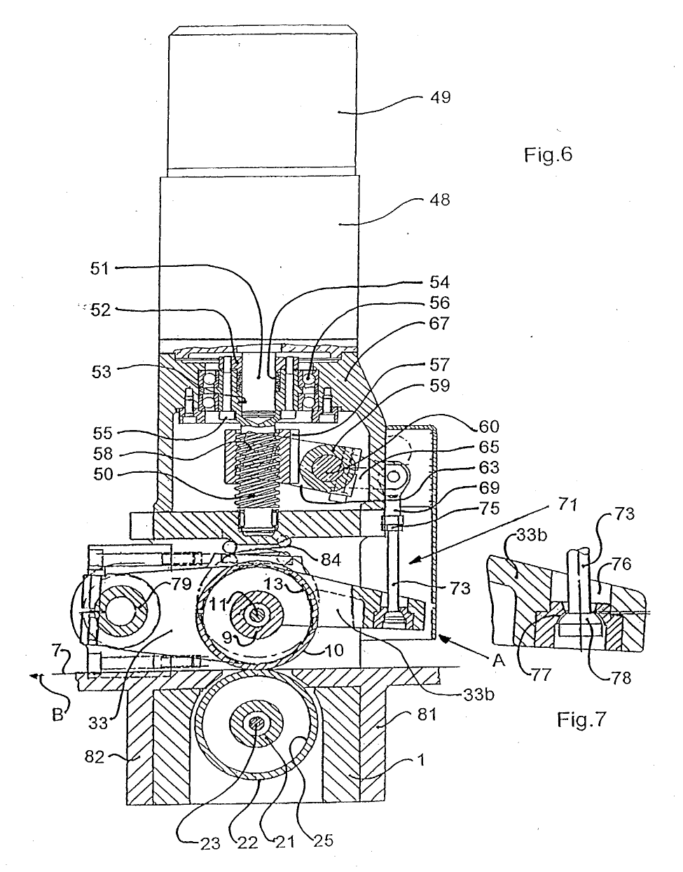

Each lower shaft portion 72 and 73, resp. projects through a respective opening 76 in the rocker 33 and a shoulder 77 is formed in this opening 76 (see FIGS. 6 and 7). Each lower shaft portion 72 and 73, resp. ends, furthermore, in a abutment head 78.

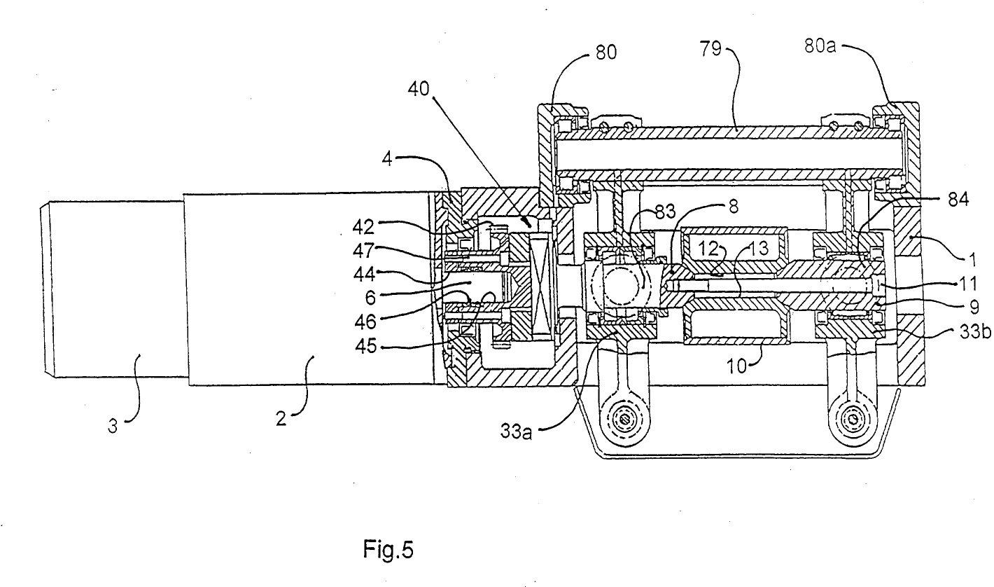

The rocker 33, in which the upper feeding roller 10 is supported, is mounted at its end opposite the control rods 70 and 71, resp. to a shaft 79. This shaft 79 is supported in the frame 1. The bearing 80, 80a of the shaft 79 are shown in FIGS. 4 and 5.

Thus, it can be seen that the rocker 33 inclusive the upper feeding roller 10 supported in the rocker can perform rocking, that is pivoting movements around the shaft 79. Accordingly, the upper feeding roller 10 can be moved against the lower feeding roller 22 and the metal strip 7 fed in the direction of the arrow B resting thereupon, and again away from the lower feeding roller 22.

The strip entering table 81 and the strip exiting table 82, well known in the art, are additionally shown in FIG. 6, whereby the metal strip 7 lies at both sides of the lower feeding roller 22 on these two tables 81, 82.

The rocker 33 is biased by pressure springs 83 and 84, resp. against the lower feeding roller 22.

The biasing force of the pressure springs 83, 84 is adjusted by threaded spindles 85, 86 and locking nuts 87, 88 which rest against the threaded spindle housing 67.

The adjusting proceeds by a reading of the position of discs 89, 90 relative to a scale 91, which discs rest on the pressure springs 83, 84.

Reference is made once more to FIGS. 6 and 7.

In operation of the apparatus the further electric servomotor 48 rotates initially in a first sense of rotation, so that the threaded spindle 50 rotates accordingly and causes a lowering of the control rods 70, 71. Accordingly, the rocker 33 including the upper feeding roller 10 supported in the rocker is pivoted due to the pressure springs 83, 84 downwards, thus towards the lower feeding roller 22. At the end position of this pivoting movement the upper feeding roller 10 lies on the metal strip 7 which in turn lies on the lower feeding roller 22, and exerts a pressure onto the metal strip.

In this instance, however, the further electric servomotor 48 keeps on rotating in the same sense of rotation. This leads to a no load stroke which is given by the position of the abutment head 78 relative to the shoulder 77 as shown in FIG. 7, this means that the abutment head 78 is located lower and at a distance from the shoulder 77. Conclusively, the abutment head 78 does no longer act onto the rocker 33. This ensures that the pressing force of the feeding roller onto the metal strip 7 is securely maintained by the pressure springs.

When, thereafter, the sense of rotation of the further electric servomotor 48 is reversed in order to pivot the rocker 33 upwards, the acceleration of the servomotor 48 occurs before the abutment head 78 comes to contact the shoulder 77. Because, now, for a lifting motion of the rocker 33 the further electric servomotor 48 rotates already in the respective sense of rotation before a contacting action of the abutment head 78 onto the rocker 33 occurs, a longer time span of the accelerating of the operating electric servomotor 48 before a contacting the rocker 33 is available, so that correspondingly the maximal number of strokes of the feeding apparatus and, furthermore, of the punch press is increased, so that the production output of the punch press is increased.

While there are shown and described presently preferred embodiments of the invention, it is to be distinctly understood that the invention is not limited thereto but may be otherwise variously embodied and practised within the scope of the following claims.

1. An apparatus for a intermittent feeding of a strip shaped blank (7) to a punch press which is equipped with tools adapted for a intermittent working of the strip shaped blank (7), which apparatus includes at least one intermittently operating electric servomotor (2) with a drive shaft (6), a upper shaft assembly (8,9) and a upper roller (10) mounted to said upper shaft assembly (8,9), a lower shaft assembly (20, 21) and a lower roller (22) mounted to said lower shaft assembly (8,9) of which rollers (10, 22) at least one is drivingly connected to said at least one electric servomotor (2), which rollers (10, 22) are adapted to engage the strip shaped blank (7) to be fed by a clamping of same at both its sides and to feed same intermittently by a intermittent rotational movement; wherein said upper (8, 9) and said lower shaft assembly (20, 21) each comprise a first shaft portion (8; 20) located axially adjacent said servomotor (2), and a second shaft portion (9; 21) located axially at a distance from the first shaft portion (8; 20) and remote from said servomotor (2); and wherein a respective roller (10; 22) is held in a clamped state between a respective first shaft portion (8; 20) and a respective second shaft portion (9; 21).

2. The apparatus of claim 1, and comprising threaded tightening bolts (11; 23), each extending in axial direction through a respective second shaft portion (9; 21) located remote from the servomotor (2) and resting against said second shaft portion (9; 21) and in which each threaded tightening screw bolt (11; 23) is threadingly engaged in a respective first shaft portion (8; 20) located adjacent said servomotor (2), by means of which threaded tightening bolts (11; 23) the respective first and second shaft portions (8, 9; 20, 22) are tightened against each other and accordingly against a respective roller (10; 22) located therebetween, so that each roller (10; 22) is held between respective shaft portions (8, 9; 20, 21) in a clamped state.

3. The apparatus of claim 2, wherein each roller (10; 22) features the shape of a hollow circular cylinder having a axially extending inner chamber (12; 24) with a inner circumferential wall (13; 25) and two end surface portions (14, 15; 26, 27) and having transition portions (16, 17; 28, 29) extending between a respective inner circumferential wall (13; 25) and a respective end surface portion (14, 15; 26, 27), which transition portions (16, 17; 28, 29) feature the geometrical shape of the jacket of a truncated cone; further wherein respective ends of the shaft portions (8, 9; 20, 21) which face each other include a further portion (18, 19; 30, 31) in the geometrical shape of the jacket of a truncated cone, which further portions (18, 19; 30, 31) in the geometrical shape of the jacket of a truncated cone of the shaft portions (8, 9; 20, 21) abut the respective transition portions (16, 17; 28, 29) of the rollers (10; 22).

4. The apparatus of claim 1, wherein said drive shaft (6) of said electric servomotor (2) is connected to a first spur gear (42), which first spur gear (42) is followed in axial direction of the drive shaft (6) by a multi-part coupling device (40) adapted to allow radial relative movements, which coupling device (40) is mounted in turn to said upper shaft assembly (8, 9) and which first spur gear (42) meshes with a second spur gear (43) mounted to said lower shaft assembly (20, 21).

5. The apparatus of claim 4, wherein said coupling device (40) comprises a Oldham-type coupling.

6. The apparatus of claim 4, wherein said first spur gear (42) is mounted through a multi-part clamping sleeve device (44, 45, 46) to said drive shaft (6) of said electrical servomotor (2).

7. The apparatus of claim 6, wherein said first spur gear (42) is integral with a part (45) of said multi-part clamping sleeve device (44, 45, 46).

8. The apparatus of claim 6, wherein a part of said multi-part coupling device (40) is integral with, a part (45) of said multi-part clamping sleeve-device (44, 45, 46).

9. The apparatus of claim 4, wherein said upper shaft structure (8, 9) is supported in a rocker (33) so to be movable towards said lower shaft structure (20, 21) and away from same.

10. The apparatus of claim 1, wherein said drive shaft (6) of said at least one electric servomotor (2) is connected to the shaft portion (20) of the lower shaft assembly (20, 21) which is located adjacent said at least one electric servomotor (2).

11. The apparatus of claim 10, wherein said shaft portion (20) of said lower shaft assembly (20, 21) located adjacent said at least one electric servomotor (2) is connected through a multi-part clamping sleeve device (44, 45, 46) to said drive shaft (6) of said at least one electric servomotor (2).

12. The apparatus of claim 11, wherein said shaft portion (20) of said lower shaft assembly (20, 21) located adjacent said at least one electric servomotor (2) is integral with a part (45) of said multi-part clamping sleeve device (44, 45, 46).

13. An apparatus for a intermittent feeding of a strip shaped blank (7) to a punch press which is equipped with tools adapted for a intermittent working of the strip shaped blank (7), which apparatus includes at least one intermittently operating electric servomotor (2) with a drive shaft (6), a upper shaft assembly (8, 9) and a upper roller (10) mounted to said upper shaft assembly (8, 9), a lower shaft assembly (20, 21) and a lower roller (22) mounted to said lower shaft assembly (20, 21), which upper shaft assembly (8, 9) is drivingly connected to said at least one electric servomotor (2), which rollers (10, 22) are adapted to engage the strip shaped blank (7) to be fed by a clamping of same at both its sides and to feed same intermittently by a intermittent rotational movement; which upper shaft assembly (8, 9) is supported in a rocker (33) so to be movable towards the lower shaft assembly (20, 21) and away from same, and wherein said drive shaft (6) of said electric servomotor (2) is coupled to the upper shaft assembly (8, 9) through a coupling device (40) adapted to allow radial relative movements.

14. The apparatus of claim 13, wherein a first spur gear (42) is mounted to said drive shaft (6) and is located between said electric servomotor (2) and said coupling device (40), which first spur gear (42) meshes with a second spur gear (43) which is mounted to said lower shaft assembly (20, 21).

15. The apparatus of claim 13, wherein said coupling device (40) comprises a Oldham-type coupling.

16. The apparatus of claim 14, wherein said first spur gear (42) is connected through a multi-part clamping sleeve device (44, 45, 46) to said drive shaft (16) of said electric servomotor (2).

17. The apparatus of claim 16, wherein said first spur gear (42) is integral with a part of said multi-part clamping sleeve device (44, 45, 46).

18. The apparatus of claim 16, wherein a part of said multi-part coupling device (40) is integral with a part of said multi-part clamping sleeve device (44, 45, 46).

19. The apparatus of claim 13, wherein said upper (8, 9) and said lower shaft assembly (20, 21) comprise each a first shaft portion (8; 20) located axially adjacent said electric servomotor (2), and a second shaft portion (9; 21) located axially at a distance from the respective first shaft portion (8; 20) and remote from said electric servomotor (2), and wherein a respective roller (10; 22) is held in a clamped state between a respective first shaft portion (8; 20) and a respective second shaft portion (8; 21).

20. The apparatus of claim 19, and comprising threaded tightening bolts (11; 23), each extending in axial direction through a respective second shaft portion (9; 21) located remote from the electric servomotor (2) and resting against said second shaft portion (9; 21), each threaded tightening screw bolt (11; 23) being threadingly engaged in a respective first shaft portion (8; 20) located adjacent said electric servomotor (2); by means of which threaded tightening bolts (11, 23) the respective first and second shaft portions (8, 9; 20, 21) are tightened against each other and accordingly against a respective roller (10; 22) located therebetween, so that each roller (10; 22) is held between respective shaft portions (8, 9; 20, 21) in a clamped state.

21. The apparatus of claim 20, wherein each roller (10; 22) features the shape of a hollow circular cylinder with a axially extending inner chamber (12; 24) with a inner circumferential wall (13; 25) and two end surface portions (14, 15; 26, 27) and transition portions (16, 17; 28, 29) extending between a respective inner circumferential wall (13; 25) and a respective end surface portion (14, 15; 28, 29), which transition portions (16, 17; 28, 29) feature the geometrical shape of the jacket of a truncated cone; further wherein respective ends of the shaft portions (8, 9; 20, 21) which face each other include a further portion (18, 19; 30, 31) in the geometrical shape of a truncated cone, which further portion (18, 19; 30, 31) in the shape of a truncated cone abut the respective transition portions (16, 17; 28, 29) of the rollers (10; 22).

22. An apparatus for a intermittent feeding of a strip shaped blank (7) to a punch press which is equipped with tools adapted for a intermittent working of the strip shaped blank (7), which apparatus includes a frame (1), at least one intermittently operating electric servomotor (2) with a drive shaft (6), a upper shaft assembly (8, 9) and a upper roller (10) mounted to said upper shaft assembly (8, 9), a lower shaft assembly (20, 21) and a lower roller (22) mounted to said lower shaft assembly (8, 9), of which rollers (10, 22) the upper roller (10) is drivingly connected to said at least one electric servomotor (2), which rollers (10, 22) are adapted to engage the strip shaped blank (7) to be fed by a clamping of same at both its sides and to feed same intermittently by a intermittent rotational movement; wherein said upper shaft assembly (8, 9) is supported in a rocker (33) so to be movable towards the lower shaft assembly (20, 21) and away from same, and wherein said drive shaft (6) of said electric servomotor (2) is connected through a multi-part coupling device (40) adapted to allow radial relative movements to said upper shaft assembly (20, 21), and wherein the lower shaft structure (20, 21) is supported to rotate freely in said frame (1).

23. The apparatus of claim 22, wherein said multi-part coupling device (40) comprises a Oldham-type coupling.

24. The apparatus of claim 23, wherein said multi-part coupling device (40) is connected through a multi-part clamping sleeve device (44, 45, 46) to said drive shaft (6) of said electric servomotor (2).

25. The apparatus of claim 24, wherein a part of said multi-part coupling device (40) is integral with a part (45) of said multi-part clamping sleeve device (44, 45, 46).

26. The apparatus of claim 22, wherein both said upper (8, 9) and said lower shaft assembly (20, 21) each comprise a first shaft portion (8; 20) located axially adjacent said electric servomotor (2), and a second shaft portion (9; 21) located axially at a distance from the respective first shaft portion (8; 20) and remote from said electric servomotor (2), and wherein a respective roller (10; 22) is held in a clamped state between a respective first shaft portion (8; 20) and a respective second shaft portion (9; 21).

27. The apparatus of claim 26, and comprising threaded tightening bolts (11; 23), each extending in axial direction through a respective second shaft portion (9; 21) located remote from the electric servomotor (2) and resting against said second shaft portion (9; 21), each threaded tightening bolt (11; 23) being threadingly engaged in a respective first shaft portion (8; 20) located adjacent said electric servomotor (2), by means of which threaded tightening bolts (11; 23) the respective first and second shaft portions (8, 9; 20, 21) are tightened against each other and accordingly against a respective roller (10; 22) located therebetween, so that each roller (10; 22) is held between respective shaft portions (8, 9; 20, 21 in a clamped state.

28. The apparatus of claim 27, wherein each roller (10; 22) features the shape of a hollow circular cylinder having a axially extending inner chamber (12; 24) with a inner circumferential wall (13; 25) and two end surface portions (16, 17; 28, 29) extending between a respective inner circumferential wall (13; 25) and a respective end surface portion (14, 15; 26, 27), which transition portions (16, 17; 28, 29) feature the geometrical shape of the jacket of a truncated cone, further wherein respective ends of the shaft portions (8, 9; 20, 21) which face each other include a further portion (18, 19; 30, 31) in the geometrical shape of the jacket of a truncated cone, which further portions (10, 19; 30, 31) in the shape of a truncated cone abut the respective transition portions (16, 17; 20, 29) of the rollers (10; 22).

29. An apparatus for a intermittent feeding of a strip shaped blank (7) to a punch press which is equipped with tools adapted for a intermittent working of the strip shaped blank, which apparatus includes at least one intermittently operating electric servomotor (2) with a drive shaft (6), a upper shaft assembly (8, 9) and a upper roller (10) mounted to said upper shaft assembly (8, 9), a lower shaft assembly (20, 21) and a lower roller (22) mounted to said lower shaft assembly (20, 21), of which rollers (10, 22) at least one is drivingly connected to said at least one electric servomotor (2), which rollers (10, 22) are adapted to engage the strip shaped blank (7) to be fed by a clamping of same at both its sides and to feed same intermittently by a intermittent rotational movement, which upper shaft assembly (8, 9) is supported in a rocker (33) so to be movable towards the lower shaft assembly (20, 21) and away from same; wherein both said upper (8, 9) and said lower shaft assembly (20, 21) each comprise a first shaft portion (8; 20) located axially adjacent said electric servomotor (2), and a second shaft portion (9; 21) located axially at a distance from the respective first shaft portion (8; 20) and remote from said electric servomotor (2), and wherein a respective roller (10; 22) is held in a clamped state between a respective first shaft portion (8; 20) and a respective second shaft portion (9; 21) and wherein the first shaft portion (20) of the lower shaft assembly (20, 21) is connected to the drive shaft (6) of the electric servomotor (2).

30. The apparatus of claim 29, wherein the first shaft portion (20) of the lower shaft assembly (20; 21) is connected through a multi-part clamping sleeve device (44, 45, 46) to the drive shaft (6) of the electric servomotor (2).

31. The apparatus of claim 30, wherein the first shaft portion (20) of the lower shaft assembly (20; 21) is integral with a part (45) of said multi-part clamping sleeve device (44, 45, 46).

32. The apparatus of claim 30, and comprising threaded tightening bolts (11; 23), each extending in axial direction through a respective second shaft portion (9; 21) located remote from the electric servomotor (2) and resting against said second shaft portion (9; 21); each threaded tightening screw bolt (11; 23) being threadingly engaged in a respective first shaft portion (8; 20) located adjacent said electric servomotor (2); by means of which threaded tightening bolts (11; 23) the respective first and second shaft portions (8, 9; 20, 21) are tightened against each other and accordingly against a respective roller (10; 22) located therebetween, so that each roller (10; 22) is held between respective shaft portions (8, 9; 20, 21) in a clamped state.

33. The apparatus of claim 32, wherein each roller (10; 22) features the shape of a hollow circular cylinder with an axially extending inner chamber (12; 24) with a inner circumferential wall (13; 25) and two end surface portions (14, 15; 26, 27) and transition portions (16, 17; 28, 29) extending between a respective inner circumferential wall (13; 25) and a respective end surface portion (14, 15; 20, 27), which transition portions (16, 17; 28, 29) feature the geometrical shape of the jacket of a truncated cone, further wherein respective ends of the shaft portions (8, 9; 20, 21) which face each other include a further portion (18, 19; 30, 31) in the geometrical shape of the jacket of a truncated cone, which further portions (18, 19; 30, 31) in the geometrical shape of the jacket of a truncated cone abut the respective transition portions (16, 17; 28, 29) of the rollers (10, 22).
